(19) United States
(12) Patent Application Publication
(10) Pub. No.: US 2015/0348165 A1
(43) Pub. Date: Dec. 3, 2015

(54) SERVER, METHOD, AND STORAGE MEDIUM STORING PROGRAM FOR MANAGEMENT OF SERVICE RECOMMENDATION

(71) Applicant: DeNA Co., Ltd., Tokyo (JP)

(72) Inventors: Toshiharu KUROKI, Tokyo (JP); Yusuke KAMO, Tokyo (JP); Yuka NAKAGAMI, Tokyo (JP); Sota MIZUSHIMA, Tokyo (JP)

(21) Appl. No.: 14/722,098

(22) Filed: May 26, 2015

(30) Foreign Application Priority Data
Jun. 3, 2014 (JP) 2014-114517

(51) Int. Cl. G06Q 30/06

(52) U.S. Cl. CPC G06Q 30/0631

(57) ABSTRACT

Service recommendation among users can be promoted while refraining from excessive recommendation activity. A server according to an embodiment includes an information storage unit, a screen display control unit controlling displaying screens on a terminal device, and an offering request receiving unit receiving an offering request of recommendation information. The offering request is executed without specifying a recommendation destination user. The server further includes a recommendation destination user selecting unit selecting a recommendation destination user, a recommendation information delivering unit delivering the selected destination user with the recommendation information in response to a predetermined action by a recommendation source user, a virtual object information update unit updating virtual object information necessary for executing the offering request, a recommendation information discarding unit discarding the recommendation information of which destination user has been selected if the predetermined action has not been taken by the source user until a preset time.

### CROSS-REFERENCE TO RELATED APPLICATIONS

This application is based on and claims the benefit of priority from Japanese Patent Application Serial No. 2014-114517 (filed on Jun. 3, 2014), the contents of which are hereby incorporated by reference in their entirety.

### TECHNICAL FIELD

The present invention relates to a server, method, storage medium storing a program for management of service recommendation performed among users.

### BACKGROUND

A system having a recommendation feature through which a user using a service such as a game recommends the service to other users has been proposed. For example, Japanese Patent Application Publication 2014-050745 discloses a game system in which a user can send a message to recommend a game to other users who are the user's friends on SNS.

However in such a system, the other users to which the service is recommended are limited to the friends on SNS so it is difficult to urge users who are not actively engaged and have fewer friends in SNS to make recommendation of services to other users. Whereas if recommendation of services is excessively promoted, messages to recommend services may become considered as spam and this may bring a sense of discomfort to users who receive such messages. Therefore, there is a demand for a mechanism in which the service recommendation can be promoted without limitation of the number of friends on SNS while excessive recommendation activity is refrained.

One object of an embodiment of the disclosure is to promote service recommendation performed among users while refraining from excessive recommendation activity. Other objects of the embodiments of the present disclosure will be apparent with reference to the entire description in this specification.

### SUMMARY

A server according to an embodiment is a server managing recommendation of a service performed among users. The server may include a storage device configured to store at least user information about a plurality of users; one or more computer processors configured to execute instructions. The one or more computer processor, in response to execution of the instructions, further configured to receive, from a user, an offering request to deliver recommendation information to recommend a service to a recommendation destination user, the offering request being executed without specifying the recommendation destination user; select from, among the plurality of users included in the user information, the recommendation destination user to which the recommendation information of the received offering request is delivered in accordance with a predetermined rule; and deliver the recommendation information to the selected recommendation destination user in response to execution of a predetermined action by a recommendation source user who has executed the offering request.

A method according to an embodiment of the disclosure is a method for management of service recommendation performed among users by using one or more computers. The method may include: storing at least user information about a plurality of users; receiving, from a user, an offering request to deliver recommendation information to recommend a service to a recommendation destination user, the offering request being executed without specifying the recommendation destination user; selecting from, among the plurality of users included in the user information, the recommendation destination user to which the recommendation information of the received offering request is delivered in accordance with a predetermined rule; and delivering the recommendation information to the selected recommendation destination user in response to execution of a predetermined action by a recommendation source user who has executed the offering request.

A computer-readable storage medium according to an embodiment stores a program for management of service recommendation. The program causes one or more computers that are accessible to a storage device storing at least user information about a plurality of users to: receive, from a user, an offering request to deliver recommendation information to recommend a service to a recommendation destination user, the offering request being executed without specifying the recommendation destination user; select from, among the plurality of users included in the user information, the recommendation destination user to which the recommendation information of the received offering request is delivered in accordance with a predetermined rule; and deliver the recommendation information to the selected recommendation destination user in response to execution of a predetermined action by a recommendation source user who has executed the offering request.

According to various embodiments of the disclosure, it is possible to promote service recommendation performed among users while refraining from excessive recommendation activity.

### BRIEF DESCRIPTION OF THE DRAWINGS

FIG. 1 is a block diagram schematically illustrating a system including a server 10 according to an embodiment of the present disclosure.

FIG. 2 is a block diagram illustrating the functionality of the server 10 according to an embodiment.

FIG. 3 is a diagram showing an example of information managed by a user information management table 51a according to an embodiment.

FIG. 4 illustrates the outline of mechanism to recommend a game according to an embodiment.

FIG. 5 is a diagram showing an example of information managed by a recommendation information management table 51b according to an embodiment.

FIG. 6 is a flow diagram showing an example of an offering request receiving process according to an embodiment.

FIG. 7 is a diagram showing an example of a recommendation page (front screen) 60 according to an embodiment.

FIG. 8 is a diagram showing an example of a recommendation page (an offering request screen) 70 according to an embodiment.

FIG. 9 is a flow diagram showing an example of a selection process for a recommendation destination user according to an embodiment.

FIG. 10 is a flow diagram showing an example of a recommendation information delivery process according to an embodiment.

FIG. 11 is a diagram showing an example of a recommendation page (notification screen) 80 according to an embodiment.

FIG. 12 is a diagram showing an example of a recommendation page (notification screen) 90 according to an embodiment.

FIG. 13 is a diagram showing an example of a list of messages screen 100 according to an embodiment.

FIG. 14 is a diagram showing an example of message display screen 110 according to an embodiment.

FIG. 15 is a flow diagram showing an example of a recommendation information discarding process according to an embodiment.

### DESCRIPTION OF THE PREFERRED EMBODIMENTS

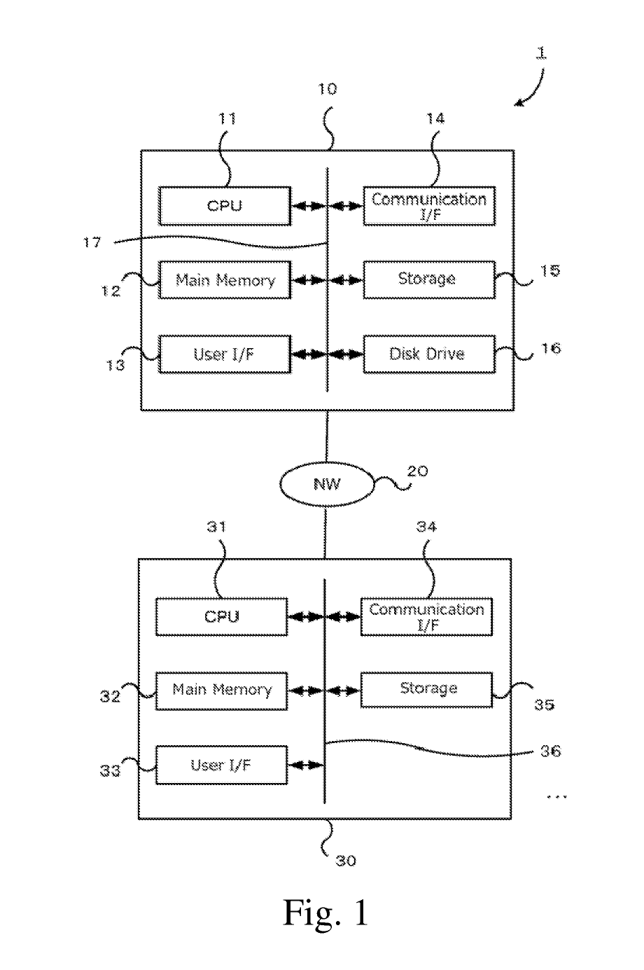

FIG. 1 is a block diagram schematically illustrating a system including a server 10 according to an embodiment of the present disclosure. The server 10 according to the embodiment is communicatively coupled to a plurality of terminal devices 30 via a communication network 20 such as Internet as illustrated in FIG. 1. The system 10 provides, to a user who is operating the terminal device 30, various digital contents service including online games, electronic books, video contents, and music contents; a communication platform (SNS platform) for implementing various user-to-user communication features such as chat (mini mail), circle, avatar, diary, message board, greeting, telephone call, etc.; and various Internet services including electronic commerce services, etc.

As illustrated in FIG. 1, the server 10 according to the embodiment is configured as a common computer device and may include a central processing unit (CPU) (computer processor) 11, a main memory 12, a user interface (I/F) 13, a communication I/F 14, a storage 15, and a disk drive 16, and these components may be electrically connected to one another via a bus 17. The CPU 11 may load an operating system and various programs into the main memory 12 from the storage 15, and may execute commands included in the loaded programs. The main memory 12 may be used to store a program to be executed by the CPU 11, and may be formed of, for example, a dynamic random access memory (DRAM). The server 10 according to an embodiment may be configured from computer devices that have the above-described hardware configurations.

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminals 30 via the communication network 20.

The storage 15 may be formed of, for example, a magnetic disk drive and store a control program for controlling various services and the like. The storage 15 may also store various data used in the various services. The various data that may be stored in the storage 15 may also be stored on a database server communicatively connected to the server 10 and physically separate from the server 10. The disk drive 16 may read data stored in a storage medium such as a compact disc read only memory (CD-ROM), digital versatile disc read only memory (DVD-ROM), or DVD Recordable (DVD-R) disc, or write data to such a storage medium.

In an embodiment, the server 10 may function as a web server for managing a web site including a plurality of hierarchical web pages and may provide the terminal device 30 with various above-mentioned Internet services through the web site. The terminals 30 may fetch HTML data for rendering a web page from the server 10 and analyze the HTML data to present the web page to a user of the terminals 30. The storage 15 may also store the HTML data for rendering the web page. The HTML data may comprise HTML documents written in markup languages such as HTML; the HTML documents may be associated with various images. Additionally, the HTML documents may include programs written in script languages such as ActionScript™ and JavaScript™.

The storage 15 may also store applications to be executed on execution environments of the terminal device 30 other than browser software. These applications may include programs for receiving services and various data such as image data to be referred to for executing the programs. The programs may be created in, for example, object oriented languages such as Objective-C™ and Java™. The created programs may be stored on the storage 15 in the form of application along with various data. The application stored on the storage 15 may be delivered to the terminal device 30 in response to a delivery request. The application delivered from the server 10 may be received by the terminal device 30 through a communication I/F 34 in accordance with the control of CPU 31; and the received program may be sent to a storage device 35 and stored thereon. The terminal device 30 may download such applications from systems (application markets) other than the server 10. The application stored in the terminal device 30 may be launched in accordance with the user's operation on the terminal device 30 and may be executed on an execution environment implemented on the terminal device 30 such as ngCore™ or Android™. The server 10 may provide the applications executed on the terminal devices 30 with various data required for providing services. Additionally, the server 10 can store various data sent from the terminal device 30 for each user, thereby managing the providing state of services (e.g., progress state of the game) for each user.

Thus, the server 10 may manage the web site for providing services and deliver web pages constituting the web site in response to a request from the terminal device 30, thereby providing various services to a user. Also, the server 10 can provide services based on communication with an application performed on the terminal device 30 in place of, or in addition to, such browser-based services. Whichever mode may be taken to provide the services, the server 10 can store data required to provide the services for each piece of identification information identifying a user. Briefly, the server 10 may also include a function to authenticate a user at start of provision of services and perform charging process in accordance with provision of services. The games provided by the server 10 may include desired games such as action games, role playing games, interactive sports games, and card games. The types of the games implemented by the server 10 are not limited to those explicitly disclosed herein.

In an embodiment, the terminal device 30 may be any information processing device that may display on a web browser a web page of a web site provided by the server 10 and include an executing environment for executing applications; and the terminal device 30 may include personal computers, smartphones, tablet terminals, and game-dedicated terminals.

As shown in FIG. 1, the terminal device 30 may include a central processing unit (CPU) (computer processor) 31, a main memory 32, a user interface (I/F) 33, a communication I/F 34, and a storage 35, and these components may be electrically connected to one another via a bus 36.

The CPU 31 may load an operating system and various programs into the main memory 32 from the storage 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The storage 35 may comprise, for example, a magnetic disk drive or a flash memory and store various programs such as an operating system. When receiving an application from the server 10 via the communication I/F 34, the storage 35 may store the received application.

A terminal 30 having such an architecture may include, for example, browser software for interpreting an HTML file (HTML data) and rendering a screen; this browser software may enable the terminal 30 to interpret the HTML data fetched from the server 10 and render web pages corresponding to the received HTML data. Further, the terminal device 30 may include plug-in software embedded into browser software; therefore, the terminal device 30 can obtain files embedded in HTML data from the server 10 (or any other server) and execute the files by using the browser software and the plug-in software.

When a service is provided to the terminal device 30, for example, animation or an operation icon designated by the program may be displayed on a screen of the terminal device 30. The user may enter an instruction for receiving the service using an input interface of the terminal device 30. The instruction entered by the user may be transmitted to the server 10 through the browser of the terminal 30 or a function of an execution environment such as ngCore™.

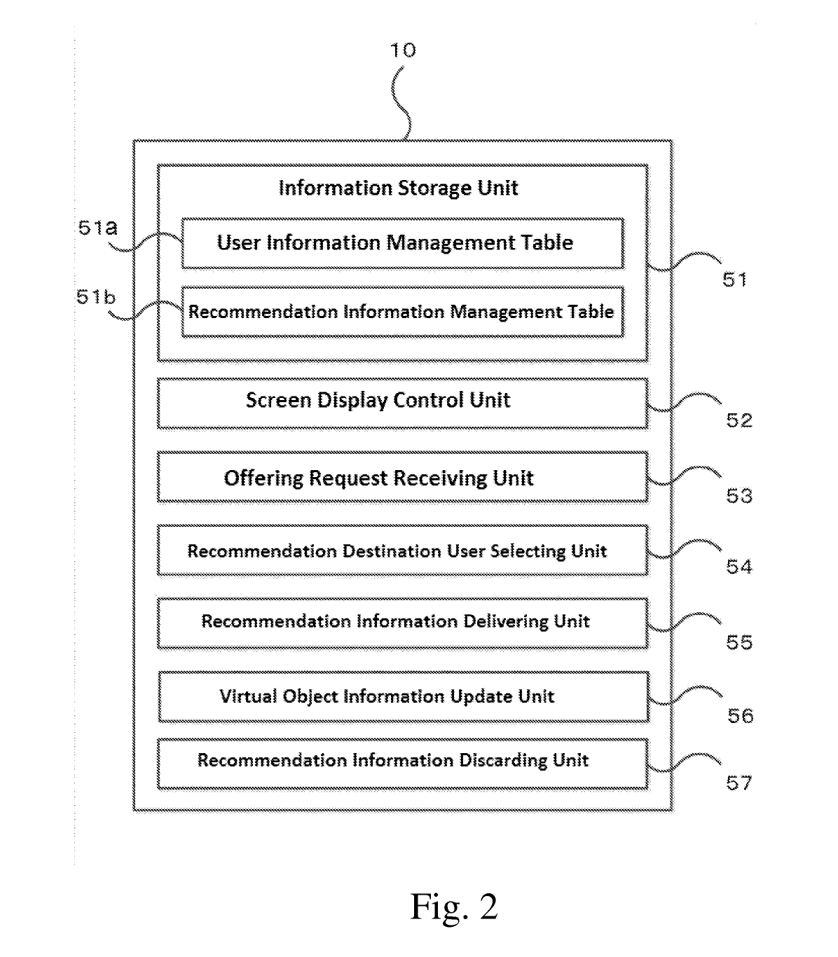

Next, operations of the above-described server 10 according to an embodiment will be now described. The server 10 according to the embodiment may include the above-described features to provide various Internet services but hereunder a feature to manage recommendation of games among users will be mainly described. FIG. 2 is a block diagram illustrating the functionality of the server 10 according to an embodiment. Referring to FIG. 2, the server 10 may include an information storage unit 51 configured to store various information, a screen display control unit 52 configured to control displaying various screens on the terminal device 30, and an offering request receiving unit 53 configured to receive an offering request from a user. The offering request is a request in which a user wishes to offer recommendation information to recommend a game to other users. Here, the offering request is carried out without specifying destination users to be sent the recommendation information. The server 10 may further include a recommendation destination user selecting unit 54 configured to select, from a plurality of users, one or more users to which the recommendation information of the received offering request is sent in accordance with a prescribed rule. The server 10 may further include a recommendation information delivering unit 55 configured to deliver the selected destination user with the recommendation information in response to a predetermined action performed by the recommendation source user who carried out the offering request. The server 10 may further include a virtual object information update unit 56 configured to update virtual object information about a virtual object necessary for executing the offering request which a user has. The server 10 may further include a recommendation information discarding unit 57 configured to discard the recommendation information of which destination user has been selected if the predetermined action has not been taken by the source user up until a preset time. These functionalities can be realized by cooperatively operating hardware such as the CPU 11 and the main memory 12 of the server 10 and software such as various programs stored in the storage 15 and the like. For example, instructions included in one or more computer programs corresponding to the above-described functionalities respectively are executed by the CPU 11 of the server 10 to realize the above-described functionalities.

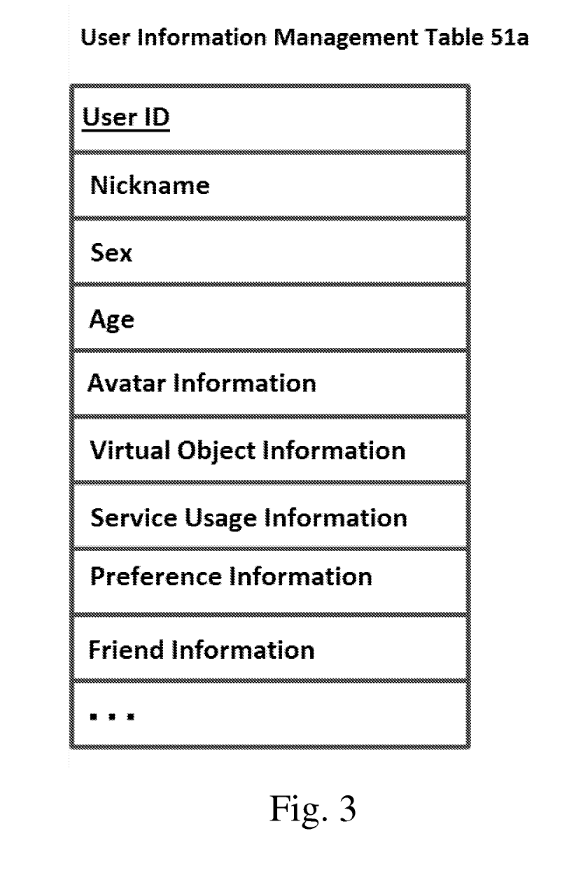

The information storage unit 51 may be realized with the storage 15 and the like of the server 10, and may include a user information management table 51a configured to manage user information of a plurality of users, and a recommendation information management table 51b configured to manage information about recommendation information of which offering request described above is accepted (a request to offer recommendation information of which destination user is not specified). FIG. 3 is a diagram showing an example of information managed by the user information management table 51a according to an embodiment. Referring to FIG. 3, the user information management table 51a may manage, in association with “user ID” identifying each user, a “nickname,” “sex,” “age” of the user, “avatar information” about the avatar of the user, “virtual object information” about the above-described virtual object which the user has, “service usage information” about services which the user uses, “preference information” indicating the user's preference for services, “friend information” about friends of the user (for example, a friend established such that one user sends a friend request and the other user accepts the request), and so on. The “nickname,” “sex,” “age,” and “avatar information” may be set at the time when a user makes user registration.

The “avatar information” may include various information about the user's avatar, for example, information related to an image corresponding to the avatar, and items set for the avatar (clothes and accessories which the avatar wears, and the like). The “service usage information” may include various information about service usage, for example, information to identify a service which the user uses, information about usage history of the user for each service (time spent on the service, frequency to use the service and the like). The “preference information” may include various information about preference for services, for example, information identifying services which the user like, classification information for classifying preferred services (categories of games) and the like. The “preference information” may be input or selected by the user himself/herself or automatically set by the server 10 based on the above-described “service usage information” and the like.

In one embodiment, users managed in the user information management table 51a are users who use at least one service among various Internet services provided by the server 10. In one embodiment, users may be divided into two categories, one is a regular user and another is a simplified user. For the simplified user, information necessary to make user registration is simplified. For instance, “sex,” “age,” “avatar information” and the like are not required. In one embodiment, usage of the above-described communication platform service is limited for the simplified user. For instance, usage of a specific functionality is limited or a range of use for a specific functionality is limited (for example, for a chatting feature, the simplified user may receive a message but cannot send a message.) For example, a user who uses a service provided by the server 10 for the first time may select to be registered as either the regular user or the simplified user.

The “virtual object information” is information about a virtual object which the user has as described above, and the virtual object is necessary for recommendation of a game (execution of the offering request of the recommendation information). Outline of a mechanism in which recommendation of a game is performed by using the virtual object will be now described according to an embodiment. In an embodiment, the virtual object may be expressed as, for example, a balloon and exchanging the recommendation information between users can be expressed as “fly a balloon” or “receive a balloon.” In other words, the virtual object (for example, a balloon) according to an embodiment is a medium that mediates the recommendation information of a game. Because a user who does not have the virtual object cannot perform game recommendation, the virtual object may also be considered as an object that enables or disables game recommendation by a user.

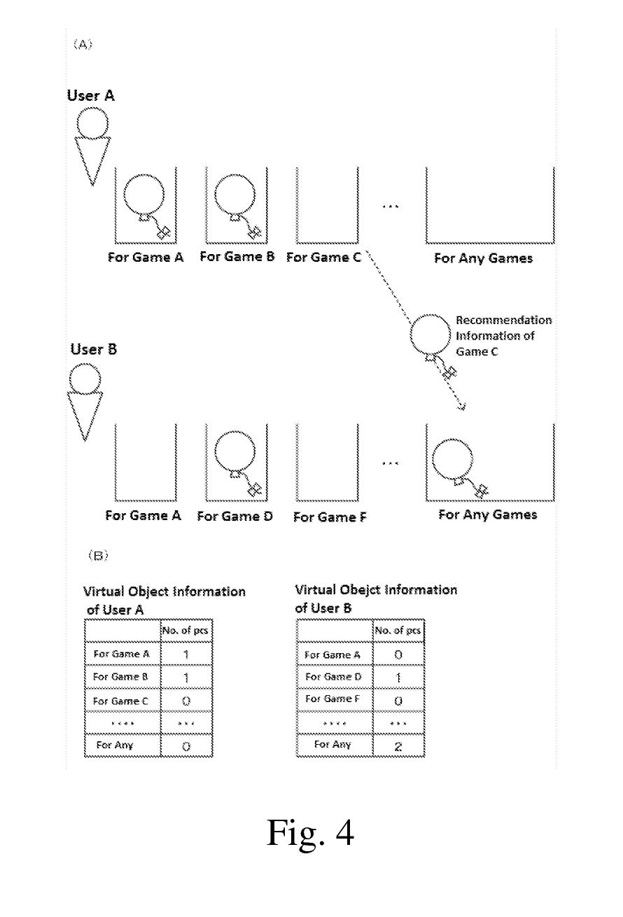

FIG. 4 illustrates the outline of mechanism to recommend a game according to an embodiment. In an embodiment, a balloon is given to a user when the user starts using a game. There are two types of the balloon, one is a first type balloon usable for recommendation of the game which the user starts using, and another is a second type balloon given to a user when a game is recommended to the user (when the user receives the recommendation information as the destination user), and usable for recommendation of any games. By using such balloons, users exchange their recommendation information. More specifically, referring to FIG. 4a, a user A starts using game A, game B, and game C. Each time the user A starts using the game, one balloon may be given to the user A and now the user A has one balloon (the first type balloon) for each game. For example, when the user A performs an offering request of recommendation information about the game C using the balloon of the game C, the user A loses the balloon C (flies the balloon). For example, the user B may be subsequently selected as a recommendation destination user by a selection process to select the recommendation destination user which will be hereunder described, the recommendation information of the game C is delivered to the user B and a balloon is given to the user B (the user B receives the balloon). The balloon given to the user B is a balloon (the second type balloon) usable for offering recommendation information of the game C recommended by the delivered recommendation information or other games (or any games). As described above, in the embodiment, the mechanism to perform recommendation of games among users is realized by “flying a balloon” and “receiving the balloon” which may be repeatedly performed.

FIG. 4b illustrates an example of the “virtual object information” managed in the user information management table 51a, and corresponds to the example shown in FIG. 4a. Referring to FIG. 4b, for each user, the number of balloons (the first type balloons) which a user has for each game (in other words, for each game information about whether there is an offering request of recommendation information of the game or not) and the number of balloons (the second type balloons) for any other game may be managed. In one embodiment, updating the “virtual object information” may be performed by the virtual object information update unit 56 of the server 10. This will be further descried later.

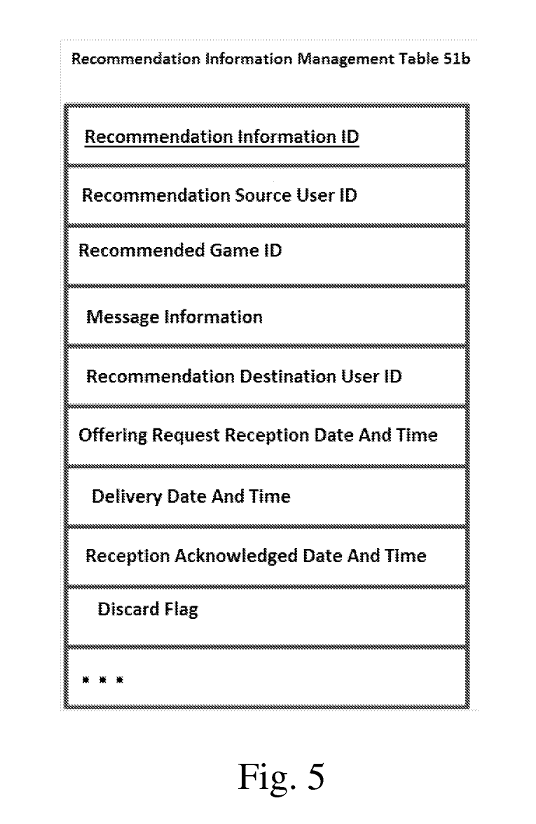

FIG. 5 is a diagram showing an example of information managed by the recommendation information management table 51b according to an embodiment. Referring to FIG. 5, the recommendation information management table 51b may manage, in association with “recommendation information ID” identifying each piece of recommendation information of which the offering request has been executed by a user, “recommendation source user ID” identifying a source user who sent the recommendation information, “recommended game ID” identifying a game which the recommendation information recommends, “message information” indicating messages included in the recommendation information, “recommendation destination user ID” identifying a destination user to which the recommendation information is sent, “offering request reception date and time” indicating the date and time when the offering request of the recommendation information is received, “delivery date and time” indicating the date and time when the recommendation information is delivered to the destination user, “reception acknowledged date and time” indicating the date and time when the recommendation destination user acknowledged the delivery (receipt) of the recommendation information, a “discard flag” indicating whether the recommendation information has been discarded or not, and so on. Although the detail of these information will be hereunder described, the information managed in the recommendation information management table 51b are adequately set according to the reception of the offering request of the recommendation information from a user, the selection of the recommendation destination user, the delivery of the recommendation information and the like.

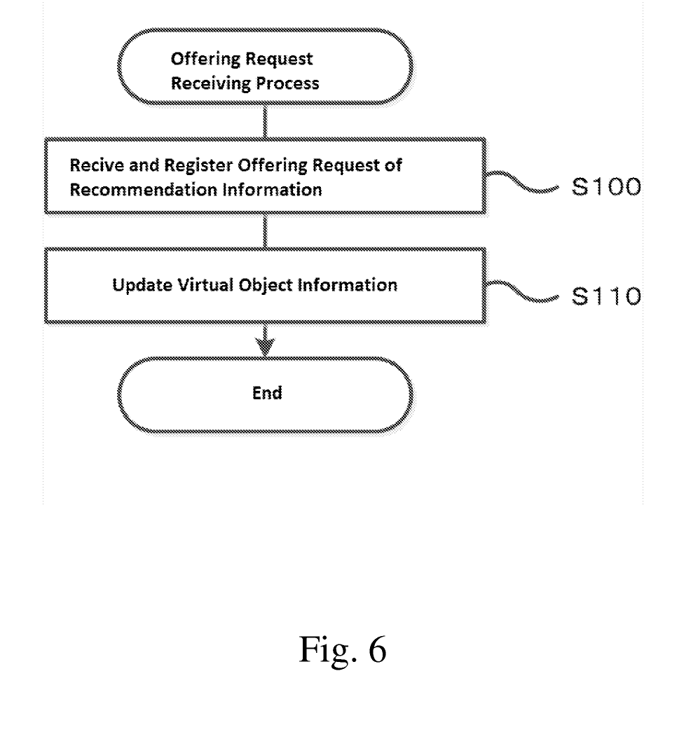

Next, operation of the server 10 according to an embodiment will be described. Firstly, an operation to receive the offering request of recommendation information will be described. FIG. 6 is a flow diagram showing an example of an offering request receiving process performed by the server 10. The offering request receiving process may be performed when a user executes an offering request of recommendation information. In an embodiment, the offering request of recommendation information by a user may be carried out through a recommendation page used for recommendation of games and displayed on the terminal device 30. Here, the recommendation page according to an embodiment will be described.

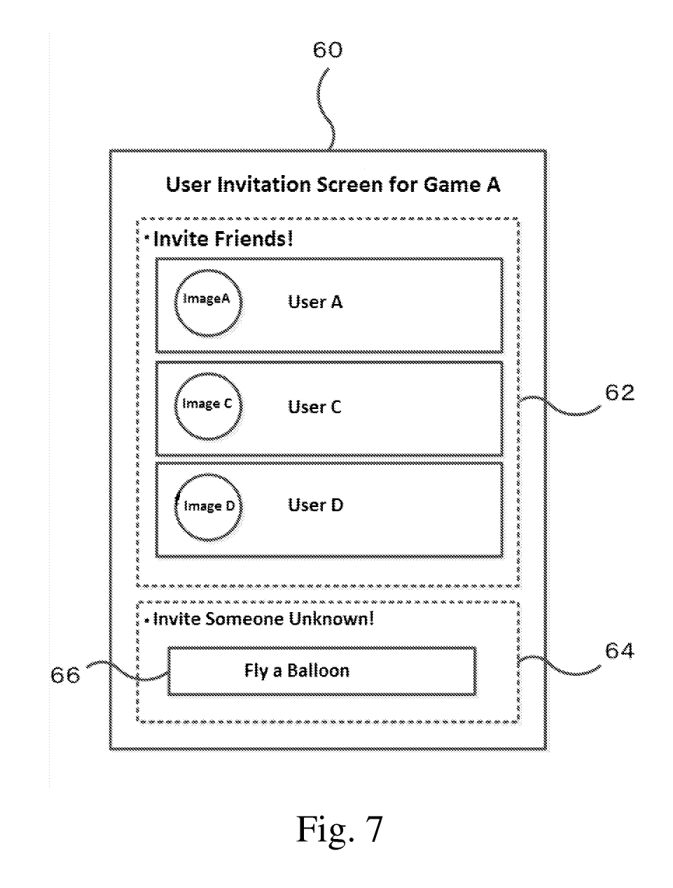

FIG. 7 is a diagram showing an example of a front screen 60 of the recommendation page according to an embodiment. Process to display each screen of the recommendation page including the front screen 60 on the terminal device 30 may be performed by the screen display control unit 52 of the server 10. More specifically, the corresponding screen data (for example, HTML data and the like) may be sent to the terminal device 30 to display the screen. The front screen 60 of the recommendation page may be accessed from, for example, various individual games' screens and then displayed (or embedded in an individual game screen as a WebView region and then displayed). For instance, the front screen 60 may be displayed when a user selects a menu for game recommendation displayed on a top page of individual games.

Referring to FIG. 7, a front screen 60 of the recommendation page may have a screen title “User Invitation Screen for Game A.” In other words, the recommendation page in this example is configured as a page used for recommendation of a game (for example, the game A) that is shown on the page previous to the front screen 60. It is also possible that a user may select a game to be recommended on the recommendation page. As shown in FIG. 7, the front screen 60 may include a friend recommendation region 62 provided on the upper side on the page to offer recommendation information to a friend (to invite a friend to a game), and an unspecified-user recommendation region 64 provided on the lower side on the page to execute an offering request of recommendation information without specifying a recommendation destination user. In the friend recommendation region 62, a list of friends of a user who operates the terminal device 30 (information about the friends is managed as the “friend information” in the user information management table 51a) may be shown as illustrated in FIG. 7, and the user may select a desired user from the users (friends) shown in the list to offer recommendation information. For example, the user may send a chat message that includes a link to a recommended game (in this example, the game A) to the selected user. Since such a process for selecting a friend to offer recommendation information is conventional to those skilled in the art, further detailed description is omitted. In the unspecified-user recommendation region 64, an offering request instruction button 66 represented as “Fly Balloon” may be provided. The offering request instruction button 66 is a button to request offering recommendation of a game by using the above-described virtual object (balloon) without specifying a recommendation destination user.

In one embodiment, in order to execute the offering request of recommendation information, a user may be required to have a balloon for recommending the game which the user recommends or a balloon for recommending any game as described above. If the user does not have the balloon for recommending the game which the user recommends or the balloon for recommending any game (this can be determined by referring the “virtual object information” in the user information management table 51a) in one embodiment, the user may not be able to select the offering request instruction button 66 to execute the offering request of recommendation information. In one embodiment, in addition, the number of executions of the offering request of recommendation information by each user may be limited such that the number of executions for a game per hour is limited to, for example, once a day (within 24 hours). In one embodiment, if the number of executions of offering request is about to exceed the limit of the number of executions for a game per hour (this can be determined by referring the “recommended game ID” and the “offering request reception date and time” in the recommendation information management table 51b), the offering request instruction button 66 may be configured to be not selectable as is the case for the user not having the balloon.

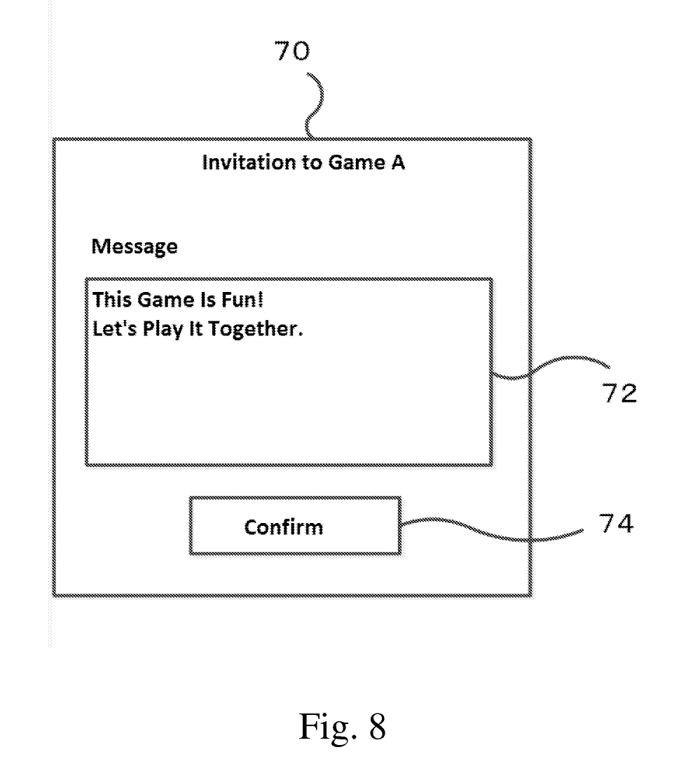

Once the offering request instruction button 66 is selected by a user, an offering request screen 70 of the recommendation page illustrated in FIG. 8 is displayed on the terminal device 30. As shown in FIG. 8, the offering request screen 70 of the recommendation page may include a message input region 72 for a user to input a message included in recommendation information, and a confirm button 74 for confirming the offering request of the recommendation information. Here, a fixed phrase may be preset in the message input region 72 and a user may be able to change the fixed phrase. Moreover, when a user is the above-described simplified user, such a user may not be allowed to input (change) a message in the message input region 72 and the preset fixed phrase may be applied as the message. When a user subsequently select the confirm button 74 on the offering request screen 70, the offering request of the recommendation information may be executed.

Now referring to the flow diagram of FIG. 6 again, in the offering request receiving process, the offering request of recommendation information executed by the user of the terminal device 30 may be then received as illustrated in FIG. 6, and the recommendation information of the received offering request is registered in the recommendation information management table 51b (step S100). This process may be performed by the offering request receiving unit 53 of the server 10. More specifically, a new record may be made in the recommendation information management table 51b, a unique number may be generated and set as the “recommendation information ID,” the user ID of the user who has executed the offering request may be set as the “recommendation source user ID,” the game ID identifying the recommended game may be set as the “recommended game ID,” the message input in the message input region 72 on the offering request screen 70 may be set as the “message information,” and the current date and time may be set as the “offering request reception date and time.”

Subsequently, the virtual object information of the user who has executed the offering request of the recommendation may be then updated (step S110), and the offering request receiving process is completed. This process may be performed by the virtual object information update unit 56 of the server 10. More specifically, if the user who executed the offering request has the balloon for the game recommended by the recommendation information, the number of the balloon for the game may be reduced by one (1), and if the user does not have the balloon for the game, the number of the balloon for any game may be reduced by one (1). In other words, the number of the balloons for the specific game is reduced (consumed) prior to the number of the balloons for any games.

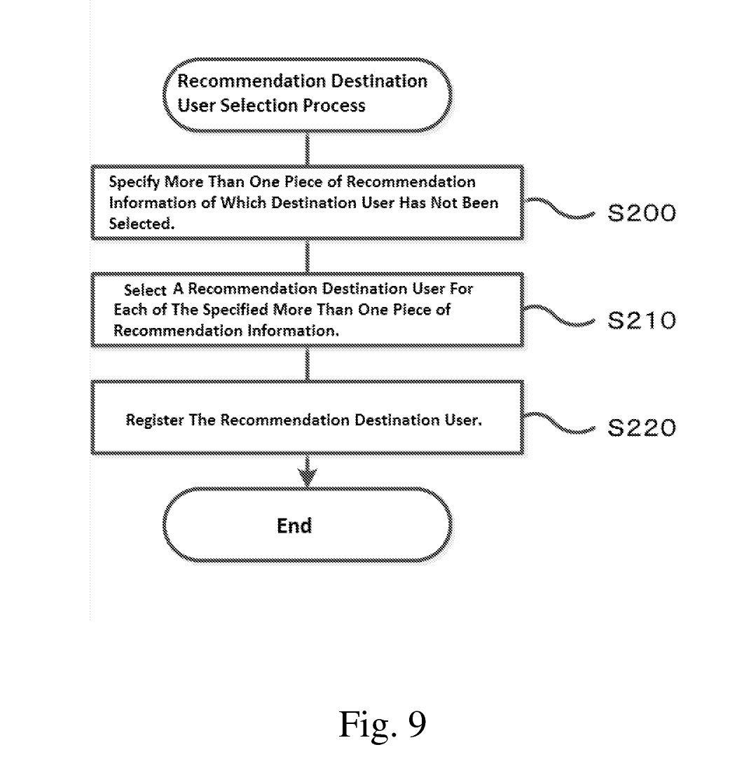

The operation to receive the offering request of recommendation information has been described. Now an operation to select a recommendation destination user to whom the recommendation information of the received offering request will be delivered will be hereunder described. FIG. 9 is a flow diagram showing an example of the selection process for a recommendation destination user performed by the recommendation destination user selecting unit 54 of the server 10. In one embodiment, the recommendation destination user selection process may be repeated at a preset time (for example, 3:00 a.m. and 2:00 p.m.) or at a predetermined time interval (for example, every four hours). In the recommendation destination user selection process, more than one piece of recommendation information of which destination user has not been selected may be specified (step S200). More specifically, search within the recommendation information management table 51b may be performed to extract records in which the “recommendation destination user ID” and the “discard flag” are not set. As described above, the recommendation destination user selection process may be repeatedly performed at the preset time or the predetermined time interval, therefore a number of pieces of recommendation information of which offering requests have been performed by users since the last recommendation destination user selection process was performed will be extracted.

Subsequently, a recommendation destination user may be specified for each of the specified more than one piece of recommendation information (step S210). In one embodiment, the recommendation destination user may be selected from among a plurality of users managed in the user information management table 51a. This selection may be performed by applying various rules. For example, as one of such rules, users who execute more offering requests (this can be estimated by referring the “recommendation source user ID” in the recommendation information management table 51b) may have a higher possibility to be selected as the recommendation destination users. By applying this rule, it is possible to select users who actively perform recommendation of games as the recommendation destination users. For example, as one of such rules, users who receive recommendation information less frequently (this can be estimated by referring the “recommendation destination user ID” in the recommendation information management table 51b) may have a higher possibility to be selected as the recommendation destination user. By applying this rule, it is possible to prevent offer of recommendation information from concentrating on certain users.

Moreover, as one of the rules, the recommendation destination user may be selected from among users who have the number of executions of the offering requests which is larger than the number of reception of the recommendation information. As described above, the number of the balloons may be decreased by executing an offering request of recommendation information and increased by receiving a piece of recommendation information. Therefore, users who has the number of executions of offering requests larger than the number of reception of recommendation information tend to have a shortage of balloons. Therefore, if such users having deficiency in the number of the balloons are selected as the recommendation destination users, the shortage of balloons can be prevented and consequently game recommendation among users can be promoted.

In one embodiment, as one of the rules, the recommendation destination user may be selected from among users who have not yet started using the game to be recommended (this can be determined by referring the “service usage information” in the user information management table 51a). In one embodiment, as one of the rules, the recommendation destination user may be selected from among users who have preferences matched with the game to be recommended (this can be determined by referring the “preference information” in the user information management table 51a).

Once the recommendation destination user is selected for each of the pieces of the recommendation information, the selected recommendation destination user may be registered in the recommendation information management table 51b (step S220), the recommendation destination user selection process may be completed. More specifically, the user ID of the selected recommendation destination user may be set as the “recommendation destination user ID” of the recommendation information management table 51b.

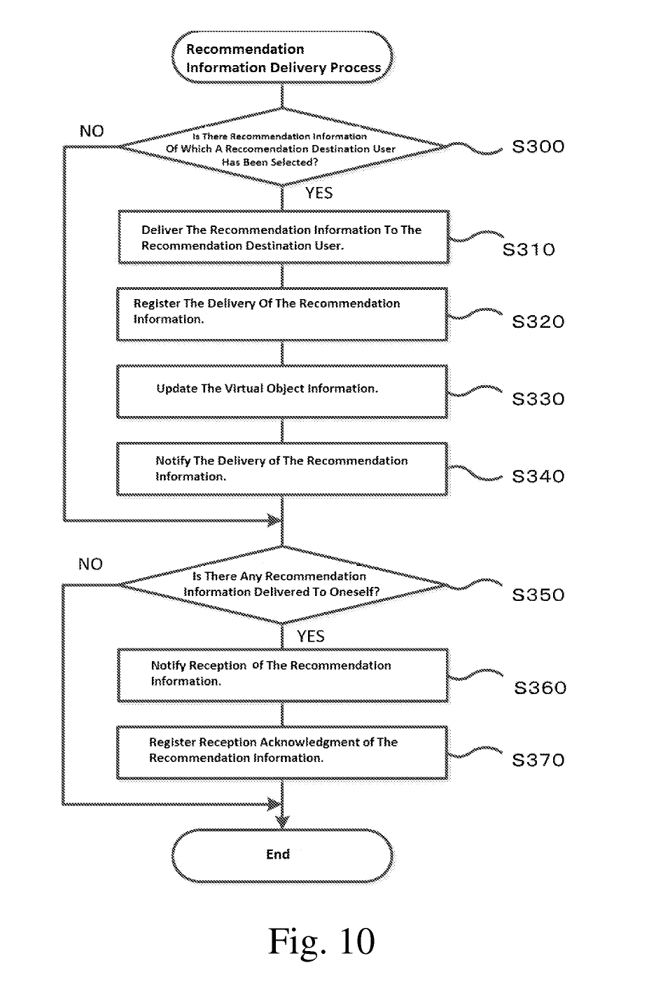

The operation to select the recommendation destination user to whom the recommendation information of the offering request is sent has been described. An operation to deliver recommendation information will be now described. FIG. 10 is a flow diagram showing an example of a recommendation information delivery process performed by the server 10 when recommendation information is delivered. This process may be performed at the time when a user accesses the above-described recommendation page in one embodiment, for example, when a user uses the terminal device 30 to access the front screen 60 of the recommendation page. Here, in one embodiment, the recommendation page may be displayed after transition from various game screens (or embedded in a game screen), and the recommendation information delivery process may be executed irrespective of games of pages from which the recommendation page is accessed (or embedded).

In the recommendation information delivery process, among the pieces of recommendation information of which the offering requests have been executed by the user of the terminal device 30 who accessed the recommendation page, it is determined whether there is a piece of recommendation information of which “(1) the recommendation destination user has been selected,” “(2) the recommendation information has not been delivered yet,” and “(3) the recommendation information has not been discarded” (step S300). This process may be performed by the offering request receiving unit 55 of the server 10. More specifically, search within the recommendation information management table 51b may be performed to determine whether there is a piece of recommendation information in which the user ID of the user of the terminal device 30 is set in the “recommendation source user ID,” any user ID is set in the “recommendation destination user ID,” the “delivery date and time” is not set, and the “discard flag” is not set.

If there is such recommendation information, this recommendation information may be delivered to the selected recommendation destination user (step S310). This process may be performed by the offering request receiving unit 55 of the server 10. More specifically, in one embodiment, a chat message corresponding to the recommendation information (a message used in a chat feature of the communication platform) may be sent to the recommendation destination user. A content of the chat message corresponding to the recommendation information will be hereunder described. As described above, in one embodiment, the recommendation information may not be delivered to the recommendation destination user when the recommendation source user executes the offering request of the recommendation information and the recommendation destination user for the recommendation information is selected. The recommendation information may be delivered to the recommendation destination user after the recommendation destination user is selected and when the recommendation source user executes a predetermined action (in this embodiment, access to the recommendation page). If there are a plurality of pieces of the recommendation information (in which recommendation destination users are selected, the plurality of pieces of the recommendation information have not been delivered yet and not discarded), the plurality of pieces of the recommendation information may be delivered to corresponding selected recommendation destination users.

Subsequently, the delivery of the recommendation information may be registered (step S320). This process may be performed by the offering request receiving unit 55 of the server 10. More specifically, the current date and time may be set in the “delivery date and time” of the recommendation information management table 51b.

The virtual object information of the recommendation destination user to which the recommendation information has been delivered may be then updated (step S330). This process may be performed by the virtual object information update unit 56 of the server 10. More specifically, because the recommendation destination user has received the recommendation information, the number of balloons for any game which the recommendation destination user has may be increased by one (1).

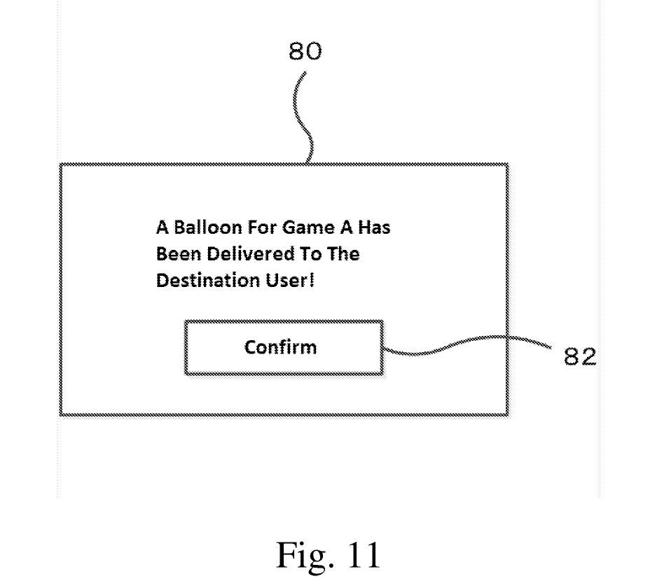

Subsequently, the delivery of the recommendation information may be notified to the recommendation source user (step S340). This process may be performed by the offering request receiving unit 55 of the server 10. More specifically, a notification screen 80 of the recommendation page is displayed on the terminal device 30 to notify the delivery of the recommendation information. FIG. 11 shows an example of the notification screen 80 displayed on the terminal device 30. Referring to FIG. 11, a text message “A balloon for game A has been delivered” may be displayed on the notification screen 80 and the user can know from this that the recommendation information of the game A of which the user executed the offering request has delivered to the recommendation destination user. When the user selects a confirm button 82, the notification screen 80 may be closed. Here, in one embodiment, the recommendation source user may not be able to know who is the recommendation destination user to which the recommendation information has delivered. Alternatively, the recommendation destination user may be shown on the notification screen 80. The notification of delivery of the recommendation information may be performed before the above-described delivery of the recommendation information (step S310) or the registration of the delivery of the recommendation information (step S320).

Here, in response to the delivery of the recommendation information to the recommendation destination user (for example, when the recommendation source user selected the confirm button 82 on the notification screen 80), a predetermined reward may be imparted to the recommendation source user. The reward given to the recommendation source user is not particularly limited but, for example, it may include an item usable in the recommended game and the like.

In the process described above, when the recommendation page is accessed from the screen of the game B (or embedded in the screen of the game B), recommendation information of any game other than the game B (for example, the game A) may be provided. However, it is also possible to limit the process to the recommendation information of the game of the previous screen to the recommendation page. In this case, the condition “(4) the recommendation information is recommendation information of the game of the previous screen” should be added to determine the recommendation information in the step S310.

Subsequently it may be determined whether there is a piece of recommendation information of which “(1) a user of the terminal device 30 who accessed the recommendation page is set as the recommendation destination user,” “(2) the recommendation information has been delivered,” and “(3) reception acknowledgment of the recommendation information is not performed” (step S350). This process may be performed by the offering request receiving unit 55 of the server 10. More specifically, search within the recommendation information management table 51b may be performed to determine whether there is a piece of recommendation information in which the user ID of the user of the terminal device 30 is set in the “recommendation destination user ID,” the “delivery date and time” is set, and the “reception acknowledged date and time” is not set.

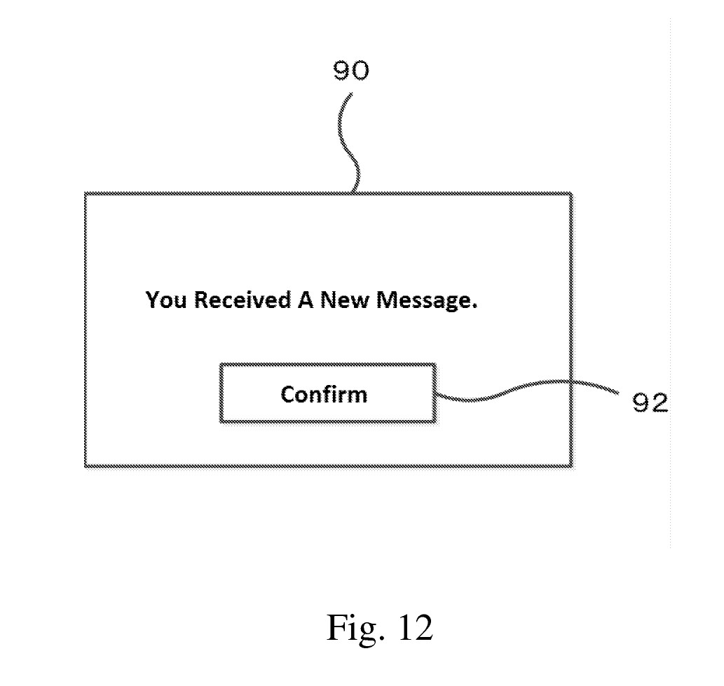

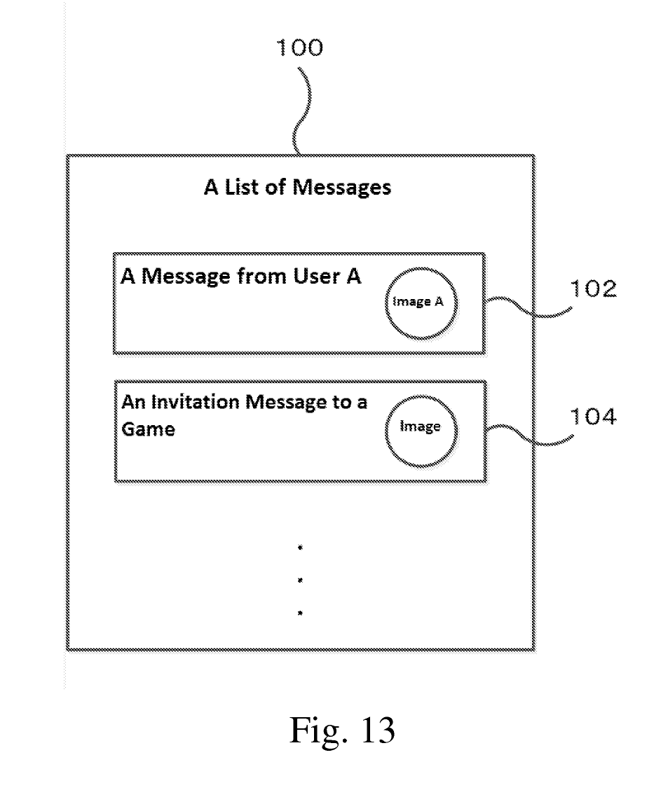

If there is such a piece of recommendation information, the reception of the recommendation information is notified to the recommendation destination user (the user who accessed the recommendation page on the terminal device 30) (step S360). This process may be performed by the offering request receiving unit 55 of the server 10. More specifically, a notification screen is displayed on the terminal device 30 to notify the reception of the recommendation information. FIG. 12 shows an example of a notification screen 90 of the recommendation page displayed on the terminal device 30. Referring to FIG. 12, a text message “you received a new message” may be displayed on the notification screen 90. When the user selected a confirm button 92 on the notification screen 90, a list of messages screen 100 may be shown on the terminal device 30 as illustrated in FIG. 13. The list of messages screen 100 may be a screen of the chat feature of the communication platform service provided by the server 10 and a list of chat messages which the user received is shown. As described above, the delivery of the recommendation information may be performed by sending a chat message in one embodiment. In the example illustrated in FIG. 13, the list of messages may include a normal (not recommendation information of a game) chat message 102 and a chat message 104 corresponding to the recommendation information. Here, in one embodiment, a sender of the chat message corresponding to the recommendation information on the chat feature may be not the recommendation source user of the recommendation information but a virtual user (for example, a user “balloon”).

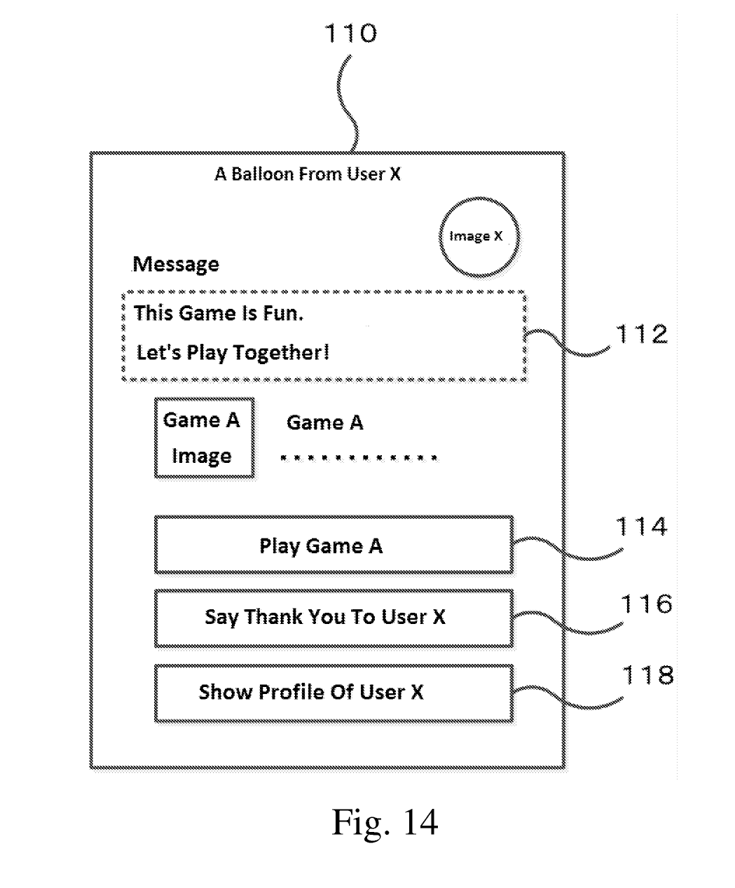

When a user selects the chat message 104 corresponding to the recommendation information among the chat messages in the list shown, a message display screen 110 may be displayed as illustrated in FIG. 14. The message display screen 110 may be a screen to show contents of chat messages. Referring to FIG. 14, information about the recommendation source user (for instance, nickname, avatar image, and the like) and information about recommended games may be displayed. Moreover, the screen 110 may include a message display region 112, a play button 114 represented as “play game A,” a thank-you button 116 represented as “say thank you to user X,” and a profile button 118 represented as “show profile of user X.” In the message display region 112, the content of the “message information” of the recommendation information management table 51b (the message input in the message input region 72 of the offering request screen 70 of the recommendation page) may be displayed. When a user selected the play button 114, a screen for starting usage of recommended game (in this example, game A) (for example, a page for downloading applications) may be displayed, and the user can start using the recommended game. When a user selected the thank-you button 116, a screen of the chat feature (or a screen of a greeting feature) and the like may be displayed and the user may be able to communicate with the recommendation source user through the chat feature (or the greeting feature). When a user selected the profile button 118, a profile screen of the recommendation source user may be displayed and the user may be able to know the profile of the recommendation source user. In the above-described manner, it is possible to encourage the recommendation destination user to use recommended games and to communicate with the recommendation source user through the chat messages corresponding to the recommendation information.

Here, when the recommendation source user is a simplified user, a part of information (for example, an avatar image) may be omitted in the chat message 104 or some buttons (for example, the third button 118 for showing the profile screen) may be disabled.

Referring again to the flow chart of FIG. 10, after the reception of the recommendation information is notified, reception acknowledgment of the recommendation information may be registered (step S370) and the recommendation information delivery process is terminated. This process may be performed by the offering request receiving unit 55 of the server 10. More specifically, the current date and time may be set in the “reception acknowledged date and time” in the recommendation information management table 51b.

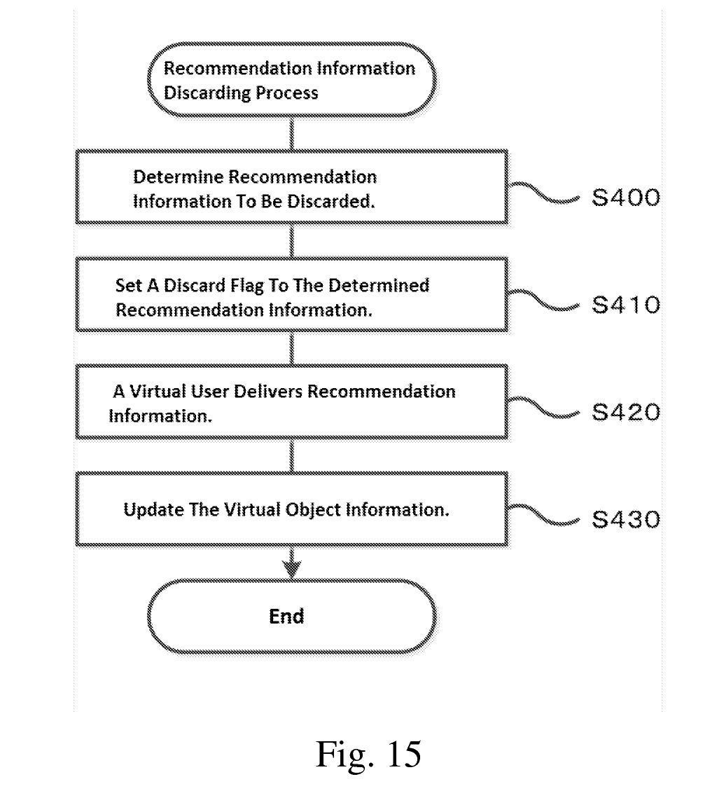

The operation to deliver the recommendation information has been described. An operation to discard recommendation information will be now described. FIG. 15 is a flow diagram showing an example of a recommendation information discarding process performed by the server 10 when the recommendation information is discarded. In one embodiment, this process may be repeated at a preset time (for example, at 3:00 a.m.) or at a predetermined time interval (for example, every twelve hours). Referring to FIG. 15, in the recommendation information discarding process, recommendation information that is to be discarded may be firstly determined (step S400). This process may be performed by the recommendation information discarding unit 57 of the server 10. More specifically, when a recommendation source user has not accessed the recommendation page for a long time and delivery of recommendation information to a recommendation destination user is suspended for a long time, such recommendation information may be the ones to be discarded. Such recommendation information may be recommendation information that has not been delivered to the recommendation destination user up until a prescribed time point (for example, a predetermined time period (ex. three days) has passed since an offering request of the recommendation information was received, or a predetermined time period has passed since the recommendation destination user was selected (in this case, the date and time when the recommendation destination user was selected may be registered in the recommendation information management table 51b) and the like), and this recommendation information can be determined by making a search within the recommendation information management table 51b.

A discard flag may be set to the determined recommendation information to be discarded (step S410). This process may be performed by the recommendation information discarding unit 57 of the server 10. More specifically, for the recommendation information to be discarded, a predetermined value (for example, value “1”) may be set in the “discard flag” in the recommendation information management table 51b.

In response to setting of the discard flag, a virtual user may deliver recommendation information to the recommendation destination user of the recommendation information to which the discard flag is set (step S420). This process may be performed by the recommendation information discarding unit 57 of the server 10. A content of the recommendation information which the virtual user (for example, a certain character) delivers may be set by applying various rules. For instance, irrespective of the recommendation destination users, the content of the recommendation information may be information about campaign for the same game, or information to recommend games matched with the preference of each recommendation destination user. The delivery of the recommendation information by the virtual user may be performed by sending a chat message in the same manner as the (existent) recommendation source user delivers the recommendation information as described above.

The virtual object information of the recommendation destination user to which the recommendation information is delivered by the virtual user may be then updated (step S430), and the recommendation information discarding process is terminated. This process may be performed by the virtual object information update unit 56. More specifically, the number of balloons for any game of the recommendation destination user to which the virtual user delivered the recommendation information may be increased by one (1). In one embodiment, if the recommendation information has not been delivered because the recommendation source user does not access the recommendation page for a long time, such a recommendation information may be discarded as described above and the virtual user may deliver recommendation information instead. In this manner, it is possible to prevent users who have shortage of balloons from being generated because recommendation information is delivered and a balloon will be given.

Here, the discard of recommendation information and the delivery of recommendation information by a virtual user described above may alternatively be performed at other timings or under other conditions. For example, if a user who is selected as the recommendation destination user of the recommendation information through the above-described recommendation destination user selection process starts usage of the game recommended by the recommendation information before the delivery of the recommendation information (for instance, the user downloaded the corresponding application before the delivery), the delivery of the recommendation information may be aborted, the recommendation information may be then discarded, and a virtual user may deliver recommendation information to the recommendation destination user.

In the above-described embodiment, one balloon usable for recommendation of the game is imparted in response to the start of usage of the game, and one balloon usable for recommendation of any game is imparted in response to the reception of the recommendation information. However, two or more balloons may be imparted. Moreover, all the balloons may be usable for recommendation of specific games or all the balloons may be usable for recommendation for any games.

According to the above described embodiment, the server 10 may receive an offering request to deliver recommendation information to recommend a game to a recommendation destination user, the offering request may be executed without specifying the recommendation destination user. The server 10 may then select from among a plurality of users the recommendation destination user to which the recommendation information of the received offering request is delivered. The server 10 may further deliver the recommendation information to the selected recommendation destination user in response to the access to the recommendation page (execution of a predetermined action) by the recommendation source user who has executed the offering request. In this manner, a user can perform the offering request of recommendation information without specifying recommendation destination users so that the user can recommend a service such as a game to other users regardless of whether the user has friends on SNS or not. Therefore, it is possible to promote service recommendation to various users. Moreover, according to the embodiment, the delivery of the recommendation information to the selected recommendation destination user may be performed in response to a predetermined action by the recommendation source user. Therefore, compared to the case where the recommendation information is immediately delivered, it is possible to restrain excessive recommendation activity.

In addition, according to one embodiment, the server 10 may require a balloon (a virtual object) to execute an offering request of recommendation information. A user may gain a balloon when the user starts using a game, lose a balloon when the user executes an offering request, and gain a balloon when the user receives recommendation information. Because the number of balloons required for performing game recommendation is adequately controlled in this manner, it is possible to restrain excessive recommendation activity among users.

Although recommendation information is delivered in response to access to the recommendation page by the recommendation source user in the above-described embodiments, the recommendation information may be delivered in response to other actions (including actions that do not use the recommendation page) by the recommendation source user.

Although service recommendation is managed by using a virtual object (balloon) required for execution of an offering request of recommendation information in the above-described embodiments, the virtual object may not be necessarily used. For instance, in other embodiments, the number of times which an offering request of recommendation information can be executed may be managed. The number of executable offering requests may be increased in response to a start of service usage by a user, may be reduced in response to execution of the offering request of recommendation information by the user, and may be increased in response to reception of recommendation information by the user as the recommendation destination user.

Although the mechanism to manage recommendation of games among users has been described in the above embodiments, embodiments of the present disclosure can also applied to management of various services other than games.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A server managing recommendation of a service performed among users, comprising:
a storage device configured to store at least user information about a plurality of users; and
one or more computer processors configured to execute instructions, the one or more computer processor, in response to execution of the instructions, further configured to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule; and
deliver the recommendation information to the selected recommendation destination user in response to execution of a predetermined action by a recommendation source user who has executed the offering request,
wherein in response to a start of service usage by a user, the offering request of recommendation information to recommend the service becomes executable at a predetermined number of times.

2. A server managing recommendation of a service performed among users, comprising:
a storage device configured to store at least user information about a plurality of users;
one or more computer processors configured to execute instructions, the one or more computer processor, in response to execution of the instructions, further configured to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule;
deliver the recommendation information to the selected recommendation destination user in response to execution of a predetermined action by a recommendation source user who has executed the offering request,
wherein in response to reception of the recommendation information by a user as the recommendation destination user, the offering request of recommendation information to recommend a service recommended by the recommendation information or to recommend other services becomes executable at a predetermined number of times.

3. A server managing recommendation of a service performed among users, comprising:
a storage device configured to store at least user information about a plurality of users;
one or more computer processors configured to execute instructions, the one or more computer processor, in response to execution of the instructions, further configured to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule;
deliver the recommendation information to the selected recommendation destination user in response to execution of a predetermined action by a recommendation source user who has executed the offering request,
wherein the number of execution of the offering request per unit time for one service is limited.

4. A server managing recommendation of a service performed among users, comprising:
a storage device configured to store at least user information about a plurality of users;
one or more computer processors configured to execute instructions, the one or more computer processor, in response to execution of the instructions, further configured to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule;
deliver the recommendation information to the selected recommendation destination user in response to execution of a predetermined action by a recommendation source user who has executed the offering request,
wherein the predetermined rule includes a rule in which a user who executes the offering request at a larger number of times has a higher possibility to be selected as the recommendation destination user.

5. A server managing recommendation of a service performed among users, comprising:
a storage device configured to store at least user information about a plurality of users;
one or more computer processors configured to execute instructions, the one or more computer processor, in response to execution of the instructions, further configured to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule;
deliver the recommendation information to the selected recommendation destination user in response to execution of a predetermined action by a recommendation source user who has executed the offering request,
wherein the predetermined rule includes a rule in which a user who receives the recommendation information at a smaller number of times has a higher possibility to be selected as the recommendation destination user.

6. The server of claim 1, wherein the offering request is executed through a recommendation page used for service recommendation, and the predetermined action is performed through the recommendation page.

7. The server of claim 6, wherein the predetermined action is access to the recommendation page.

8. The server of claim 1, wherein the user information includes preference information about the user's preference for the service, and the predetermined rule includes a rule in which the recommendation destination user is selected from among users who have preferences matched with the service recommended by the recommendation information based on the preference information.

9. The server of claim 1, wherein the user information includes virtual object information about a virtual object which a user has and is required for execution of the offering request, and the one or more computer processor, in response to execution of the instructions, further configured to update the virtual object information of the user at a predetermined timing.

10. The server of claim 9, wherein the update of the virtual object information includes reducing the number of the virtual objects of the user in response to execution of the offering request by the user.

11. The server of claim 9, wherein the update of the virtual object information includes imparting the virtual object to the user in response to start of service use by the user.

12. The server of claim 9, wherein the update of the virtual object information includes imparting the virtual object to the user in response to reception of the recommendation information by the user as the recommendation destination user.

13. The server of claim 9, wherein the virtual object includes a first type virtual object given to a user when the user started using a service and usable for an offering request of recommendation information to recommend the service, and a second type virtual object given to a user when the user received the recommendation information as the recommendation destination user and usable for an offering request of recommendation information to recommend the service of the received recommendation information or other services.

14. The server of claim 1, wherein the selection of the recommendation destination user includes specifying a plurality of pieces of the recommendation information of the offering requests received from a plurality of the recommendation source users, and selecting collectively the recommendation destination users for the specified plurality of pieces of the recommendation information.

15. The server of claim 1, wherein the one or more computer processor, in response to execution of the instructions, are further configured to discard the recommendation information of which the recommendation destination user has been selected when the predetermined action has not been taken up until a predetermined time point by the recommendation source user.

16. The server of claim 15, wherein the discard of the recommendation information includes delivering predetermined recommendation information from a virtual recommendation source user to the recommendation destination user selected for the recommendation information to be discarded.

17. The server of claim 1 wherein the service includes a game.

18. A method for management of service recommendation performed among users by using one or more computers, comprising:
storing at least user information about a plurality of users;
receiving, from a user, an offering request to deliver recommendation information to recommend a service to a recommendation destination user, the offering request being executed without specifying the recommendation destination user;
selecting from, among the plurality of users included in the user information, the recommendation destination user to which the recommendation information of the received offering request is delivered in accordance with a predetermined rule; and
delivering the recommendation information to the selected recommendation destination user in response to execution of a predetermined action by a recommendation source user who has executed the offering request,
wherein in response to a start of service usage by a user, the offering request of recommendation information to recommend the service becomes executable at a predetermined number of times.

19. A method for management of service recommendation performed among users by using one or more computers, comprising:
storing at least user information about a plurality of users;
receiving, from a user, an offering request to deliver recommendation information to recommend a service to a recommendation destination user, the offering request being executed without specifying the recommendation destination user;
selecting from, among the plurality of users included in the user information, the recommendation destination user to which the recommendation information of the received offering request is delivered in accordance with a predetermined rule; and
delivering the recommendation information to the selected recommendation destination user in response to execution of a predetermined action by a recommendation source user who has executed the offering request,
wherein in response to reception of the recommendation information by a user as the recommendation destination user, the offering request of recommendation information to recommend a service recommended by the recommendation information or to recommend other services becomes executable at a predetermined number of times.

20. A method for management of service recommendation performed among users by using one or more computers, comprising:
storing at least user information about a plurality of users;
receiving, from a user, an offering request to deliver recommendation information to recommend a service to a recommendation destination user, the offering request being executed without specifying the recommendation destination user;
selecting from, among the plurality of users included in the user information, the recommendation destination user to which the recommendation information of the received offering request is delivered in accordance with a predetermined rule; and
delivering the recommendation information to the selected recommendation destination user in response to execution of a predetermined action by a recommendation source user who has executed the offering request,
wherein the number of executions of the offering request per unit time for one service is limited.

21. A method for management of service recommendation performed among users by using one or more computers, comprising:
storing at least user information about a plurality of users;
receiving, from a user, an offering request to deliver recommendation information to recommend a service to a recommendation destination user, the offering request being executed without specifying the recommendation destination user;
selecting from, among the plurality of users included in the user information, the recommendation destination user to which the recommendation information of the received offering request is delivered in accordance with a predetermined rule; and
delivering the recommendation information to the selected recommendation destination user in response to execution of a predetermined action by a recommendation source user who has executed the offering request,
wherein the predetermined rule includes a rule in which a user who executes the offering request at a larger number of times have a higher possibility to be selected as the recommendation destination user.

22. A method for management of service recommendation performed among users by using one or more computers, comprising:
storing at least user information about a plurality of users;
receiving, from a user, an offering request to deliver recommendation information to recommend a service to a recommendation destination user, the offering request being executed without specifying the recommendation destination user;
selecting from, among the plurality of users included in the user information, the recommendation destination user to which the recommendation information of the received offering request is delivered in accordance with a predetermined rule; and
delivering the recommendation information to the selected recommendation destination user in response to execution of a predetermined action by a recommendation source user who has executed the offering request,
wherein the predetermined rule includes a rule in which a user who receives the recommendation information at a smaller number of times has a higher possibility to be selected as the recommendation destination user.

23. A computer-readable storage medium storing a program for management of service recommendation, the program causing one or more computers accessible to a storage device storing at least user information about a plurality of users to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule; and
deliver the recommendation information to the selected recommendation destination user in response to execution of a predetermined action by a recommendation source user who has executed the offering request,
wherein in response to a start of service usage by a user, the offering request of recommendation information to recommend the service becomes executable at a predetermined number of times.

24. A computer-readable storage medium storing a program for management of service recommendation, the program causing one or more computers accessible to a storage device storing at least user information about a plurality of users to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule; and
deliver the recommendation information to the selected recommendation destination user in response to execution of a predetermined action by a recommendation source user who has executed the offering request,
wherein in response to reception of the recommendation information by a user as the recommendation destination user, the offering request of recommendation information to recommend a service recommended by the recommendation information or to recommend other services becomes executable at a predetermined number of times.

25. A computer-readable storage medium storing a program for management of service recommendation, the program causing one or more computers accessible to a storage device storing at least user information about a plurality of users to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule; and
deliver the recommendation information to the selected recommendation destination user in response to execution of a predetermined action by a recommendation source user who has executed the offering request,
wherein the number of executions of the offering request per unit time for one service is limited.

26. A computer-readable storage medium storing a program for management of service recommendation, the program causing one or more computers accessible to a storage device storing at least user information about a plurality of users to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule; and
deliver the recommendation information to the selected recommendation destination user in response to execution of a predetermined action by a recommendation source user who has executed the offering request,
wherein the predetermined rule includes a rule in which a user who executes the offering request at a larger number of times have a higher possibility to be selected as the recommendation destination user.

27. A computer-readable storage medium storing a program for management of service recommendation, the program causing one or more computers accessible to a storage device storing at least user information about a plurality of users to:
receive, from a user, an offering request to deliver recommendation information to recommend a service to a recommendation destination user, the offering request being executed without specifying the recommendation destination user;
select from, among the plurality of users included in the user information, the recommendation destination user to which the recommendation information of the received offering request is delivered in accordance with a predetermined rule; and
deliver the recommendation information to the selected recommendation destination user in response to execution of a predetermined action by a recommendation source user who has executed the offering request,
wherein the predetermined rule includes a rule in which a user who receives the recommendation information at a smaller number of times has a higher possibility to be selected as the recommendation destination user.
